(19) United States
(12) Patent Application Publication
(10) Pub. No.: US 2020/0276590 A1
(43) Pub. Date: Sep. 3, 2020

(54) HEAT SHIELD FOR CONE CRUSHER

(71) Applicant: McCloskey International Limited, Keene (CA)

(72) Inventors: Dennis Duellman, Cudahy, WI (US); Marian Ando, Cudahy, WI (US); Andrzej Krol, Keene (CA)

(73) Assignee: McCloskey International Limited, Keene (CA)

(21) Appl. No.: 16/288,338

(22) Filed: Feb. 28, 2019

(51) Int. Cl. B02C 2/00

(52) U.S. Cl. CPC B02C 2/005; B02C 2210/02

(57) ABSTRACT

A mantle is provided that is disposed over a cone head of a cone crusher, including an outer surface designed to cooperate with a crusher liner to crush rocks that enter a crushing zone between the outer surface of the mantle and the crusher liner. Also provided is a mantle nut and washer assembly for mounting the mantle to the cone head. The mantle includes a flange extending around an inner surface of the mantle between the inner surface of the mantle and the mantle nut and washer assembly to absorb heat generated when performing cutting operations to remove and replace the mantle.

### TECHNICAL FIELD

Embodiments herein relate to the field of cone crushers and, more specifically, to a protective shield that can provide protection to the crusher components during removal of a cone liner.

### BACKGROUND

Rock crushers reduce the size of rocks in order to provide material for roadbeds, concrete, building foundations and the like. Rock crushers may be categorized as cone crushers, jaw crushers, and impact crusher, but this disclosure will focus on cone crushers. Cone crushers break up rocks and other hard material by squeezing or compressing the rocks between a convex, gyrating crusher cone head and a concave, stationary crusher bowl, both of which are covered by hardened wear surfaces. The cover for the cone head is typically called a mantle. The cover for the crusher bowl is normally called a bowl liner.

The spacing between the bowl liner and the mantle at any given point opens and closes as the cone gyrates relative to the inside of the bowl. This space between the liner and the mantle is typically called the crushing space. Rocks are fed into the crushing space and slide down between these surfaces as the space opens with the gyration of the mantle, and the rocks are crushed as the space closes. As a result of the forces and abrasion that occurs during cone crushing operations, it is common that the gyrating mantle and the stationary bowl liner need to be replaced from time to time.

Because the mantle is so securely fastened to the other components of the cone, the mantle typically has to be removed using a torch to cut through the steel holding it in place. This involves either cutting through what is called the mantle flange or cutting through a mantle washer. In either event, the heat generated during the cutting process jeopardizes the integrity of the other components of the cone, which may partially melt or become warped during the cutting process.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1 is a side elevation sectional view of a portion of a cone crusher depicting an embodiment of a heat shield flange as part of an integral mantle, showing a cut line in phantom where the mantle may be cut to be removed;

FIG. 2 is a side elevation sectional view of a portion of a cone crusher depicting the embodiment of the heat shield flange of FIG. 1, showing a cut line in phantom being taken through a mantle washer with the mantle cap and adjacent components removed;

FIG. 3 is a side elevation sectional view of a torch ring including a heat shield flange;

FIG. 4 is a perspective view of the torch ring of FIG. 3;

FIG. 5 is a perspective view of a cone head having a short design mantle having the torch ring of FIGS. 3 and 4 mounted thereto; and

FIG. 6 is a side elevation sectional view of a cone crusher with a short design mantle and the torch ring of FIGS. 3-5 mounted in place, showing one area in which the torch ring may be cut to be removed from the cone head.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense.

Various operations may be described as multiple discrete operations in turn, in a manner that may be helpful in understanding embodiments; however, the order of description should not be construed to imply that these operations are order-dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

Cone head and mantle designs vary from crusher to crusher but there are two most common designs. The first includes an integral mantle placed over the cone head. The second includes a mantle sometimes called a “short design,” which covers most of the cone head, with what is called a “torch ring” mounted over the upper portion of the cone head. As noted above, given the violent and abrasive crushing action that takes place in a crushing space between the mantle and the bowl liner, these components need to be replaced from time to time. Removal of the mantle can be particularly problematic given that wear and damage to the mantle during normal crushing operations renders the mantle very difficult to be removed from the cone head. One method of removing the mantle, whether it be an integral mantle or a two-part mantle with a torch ring at the top, is to use a torch to cut through the upper portion of the mantle or the torch ring. As noted above, a problem with this cutting operation is that an incredible amount of heat is generated in order to cut through the thick and hardened mantle, which is normally fabricated of extremely hard manganese. The heat can be so severe that the surrounding components of the cone head can be warped or even partially melted during the cutting operation. In order to protect the adjacent components of the cone head, a flange can be added to the underside of the mantle or the torch ring. That flange is the focus of the present disclosure.

Embodiments disclosed herein include a mantle that is disposed over a cone head of a cone crusher, including an outer surface designed to cooperate with a crusher liner to crush rocks that enter a crushing zone between the outer surface of the mantle and the crusher liner. Also provided is a mantle nut and washer assembly for mounting the mantle to the cone head. The mantle includes a flange extending around an inner surface of the mantle between the inner surface of the mantle and the mantle nut and washer assembly to absorb heat generated when performing cutting operations to remove and replace the mantle.

The flange and the inner surface of the mantle may define an open area for receiving slag and other debris generated during a cutting operation. The mantle nut and washer assembly may include a washer, and the flange may extend from the inner surface of the mantle to a point adjacent the washer. The flange may be tapered and extend somewhat upwardly from the inner surface of the mantle.

Other embodiments of the disclosure may include a cone crusher having a mantle, a torch ring mounted to an upper portion of the mantle, and a mantle nut and washer assembly for holding the mantle and the torch ring in place. In this embodiment the torch ring may include an inner surface and a flange extending from the inner surface of the torch ring to a point adjacent the mantle nut and washer assembly.

The flange and the inner surface of the torch ring may define an open area for receiving slag and other debris generated during a cutting operation. The mantle nut and washer assembly may include a washer, and the flange may extend from the inner surface of the torch ring to a point adjacent the washer. The flange may be tapered and extend somewhat upwardly from the inner surface of the torch ring.

Embodiments of the disclosure may include a torch ring to be used in a cone crusher including a short mantle, the torch ring having outer and inner surfaces and being mounted to the cone crusher immediately above the mantle adjacent a mantle nut and washer assembly. In that embodiment the improvement may comprise a flange extending inwardly from the inner surface of the torch ring, designed to extend to a point adjacent the mantle nut and washer assembly to absorb heat generated when the torch ring needs to be cut off of the cone crusher.

When mounted to a cone crusher an open area may be defined between the inner surface of the torch ring and the flange for receiving slag and other debris generated during a torch ring cutting operation. The mantle nut and washer assembly may include a washer, and the flange may be designed to extend from the inner surface of the torch ring to a point adjacent the washer when mounted to a cone crusher.

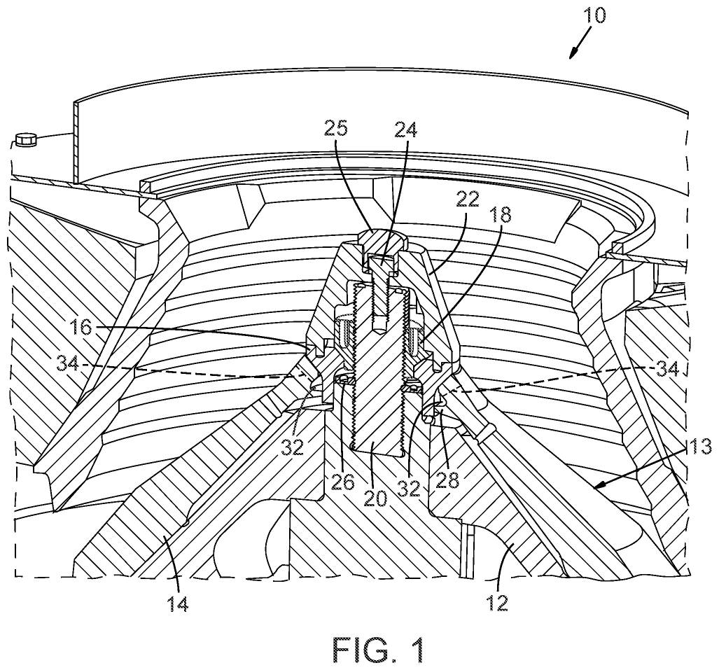

FIG. 1 depicts a crusher cone generally indicated at 10, with a cone assembly 13 and a cone head 12. In this embodiment, cone head 12 is covered with an integral mantle 14 that extends and protects the entire cone head. A mantle washer 16 is positioned adjacent mantle 14, and a mantle nut 18 fastens the mantle washer and in turn the mantle in place. A threaded stud shaft 20 extends through the center of mantle washer 16 and mantle nut 18, and a mantle cap 22 is mounted over the mantle nut and mantle washer to provide protection from the crushing action taking place immediately therebelow. A mantle bolt 24 secures the assembly in place, and bolt cap 25 may be positioned over the mantle bolt. Bolt cap 25 may be welded or otherwise securely fastened to the top of mantle cap 22. A shaft retaining ring 26 is typically used to fix the position of stud shaft 20 with respect to the other components.

To protect the components of cone head 10 during mantle cutting operations described earlier, an annular mantle flange 28 extends around an inner surface of mantle 14 between the mantle and what might be called a mantle mounting assembly. In the depicted embodiment, the mantle mounting assembly includes the mantle nut 18 and a mantle washer 16 but it might include other or additional components. In the depicted embodiment, mantle flange 28 extends from the inner surface of mantle 14 to mantle washer 16.

Mantle flange 28 is heavy enough to absorb the heat generated during the cutting operation and but does not otherwise interfere with crushing operations and does not add substantial weight to crusher 10. In the depicted embodiment, mantle flange 28 extends slightly upwardly and is tapered, but those are not necessary features of the mantle flange. Instead, mantle flange 28 may extend in a substantially horizontal direction or might even extend somewhat downwardly. Instead of being tapered, mantle flange 28 may even expand in configuration as it extends inwardly from an inner surface 30 of mantle 16.

FIG. 1 shows where mantle 16 may be cut to remove the mantle from cone head 12. Here a cut 34 is being taken at an angle that is approximately perpendicular to the mantle. An open area 32 defined between mantle flange 28, the inner surface 30 of mantle 16, and mantle washer 16, may be provided to collect slag and other debris generated during the cutting operation. Open area 32 is also provided so that no more of the thickness of mantle 16 needs to be cut through than is necessary.

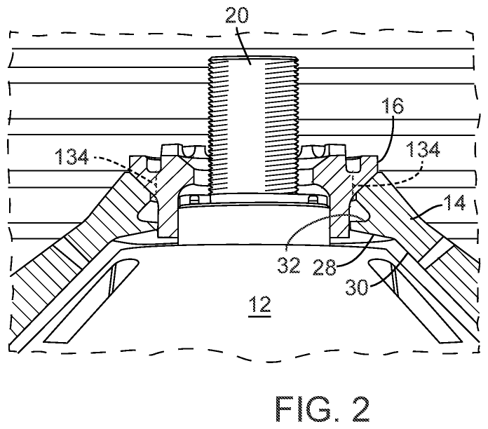

FIG. 2 depicts another manner by which mantle 16 can be cut with the mantle flange of the present disclosure. Before this cut is performed, bolt cap 25, mantle bolt 24, mantle cap 22 and mantle nut 18 would all first have to be removed. Then, a substantially vertical cut 134 may be made through mantle washer 16. This option may be particularly appropriate where the top of the mantle is seized up against and stuck to mantle washer 16. Thus, a portion of the mantle washer may be removed with mantle 16 after the cut is effected. Another advantage of this cut is that mantle washer 16 is usually fabricated of mild or cast steel, which is often easier to cut through than the manganese of which mantle 16 is normally fabricated. Again, with a cut made, slag and other debris can collect in open area 32. Components that are the same as those in FIGS. 1 have been identified with the same numerals, while the cut 134 is identified in the 100 series.

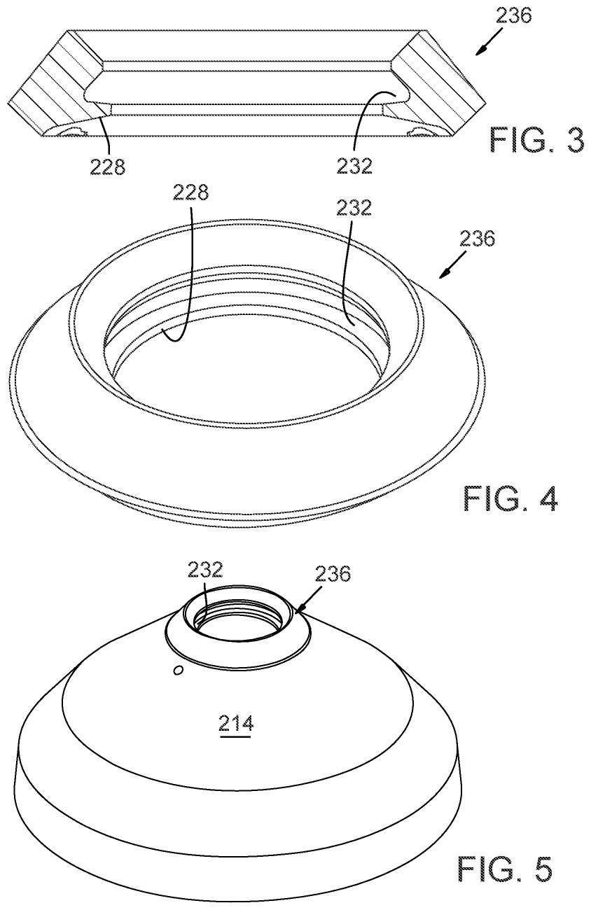

FIGS. 3-6 depict a torch ring 236 that is used when a mantle 214 is of a “short design.” As these features are similar but not the same as those in the prior figures, the components have been identified with numerals in the 200 series. Those components that may be the same as the embodiments shown in FIGS. 1-2 are identified with the same numerals.

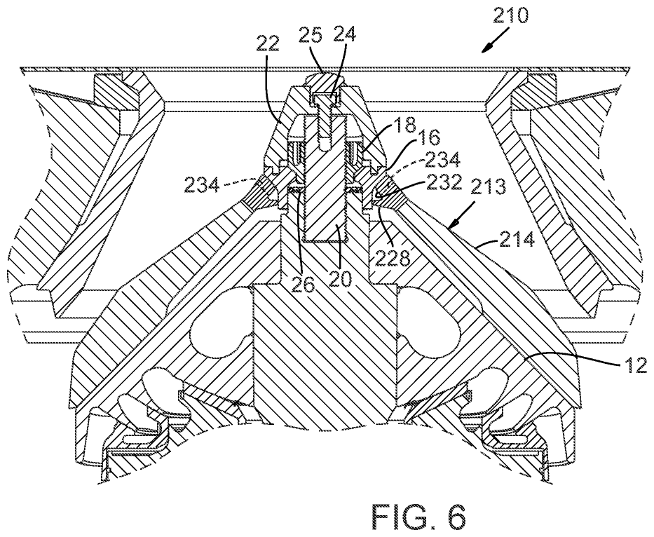

As shown in FIG. 6, torch ring 236 may mounted to the top of mantle 214 in crusher 210 in the same fashion that mantle 14 is mounted. Torch ring 236 is in the form of a separate piece, but includes the same type of circular mantle flange 228 that is included in crusher 10. Like mantle flange 28, mantle flange 228 extends around the entire periphery of the upper mantle components, and extends between the inner surface 230 of torch ring 236 and mantle mounting assembly, comprised of mantle washer 16 and mantle nut 18. In the depicted embodiment, mantle flange 228 extends between inner surface 230 of torch ring 236 and mantle washer 16. Again, mantle flange 228 is substantial enough to absorb the heat generated during cutting operations at cut 234.

As noted earlier, instead of torch ring 234 being cut at 234, the cap components may be removed and the cut may be vertical through mantle washer 16. In either case, open area 232 serves to collect slag and other debris generated during the cutting operation.

Mantle flange 228 extends substantially horizontally but may alternatively be pitched upwardly or downwardly. Between mantle flange 228, the inner surface 230 of torch ring 236 and mantle washer 16, an open area 232 is defined to collect slag and other debris generated during the cutting operation. Mantle flange 228 thus protects the other components of cone 210 from the heat generated during the cutting operation.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A mantle disposed over a cone head of a cone crusher, including an outer surface designed to cooperate with a crusher liner to crush rocks that enter a crushing zone between the outer surface of the mantle and the crusher liner, and a mantle nut and washer assembly for mounting the mantle to the cone head, wherein the mantle includes a flange extending around an inner surface of the mantle between the inner surface of the mantle and the mantle nut and washer assembly to absorb heat generated when performing cutting operations to remove and replace the mantle.

2. The mantle of claim 1 wherein the flange and the inner surface of the mantle define an open area for receiving slag and other debris generated during a cutting operation.

3. The mantle of claim 1 wherein the mantle nut and washer assembly includes a washer, and the flange extends from the inner surface of the mantle to a point adjacent the washer.

4. The mantle of claim 1 wherein the flange is tapered and extends somewhat upwardly from the inner surface of the mantle.

5. A cone crusher including a mantle, a torch ring mounted to an upper portion of the mantle, and a mantle nut and washer assembly for holding the mantle and the torch ring in place, wherein the torch ring includes an inner surface and a flange extending from the inner surface of the torch ring to a point adjacent the mantle nut and washer assembly.

6. The cone crusher of claim 5 wherein the flange and the inner surface of the torch ring define an open area for receiving slag and other debris generated during a cutting operation.

7. The cone crusher of claim 5 wherein the mantle nut and washer assembly includes a washer, and the flange extends from the inner surface of the torch ring to a point adjacent the washer.

8. The cone crusher of claim 5 wherein the flange is tapered and extends somewhat upwardly from the inner surface of the torch ring.

9. A torch ring to be used in a cone crusher including a short mantle, the torch ring having outer and inner surfaces and being mounted to the cone crusher immediately above the mantle adjacent a mantle nut and washer assembly, wherein the improvement comprises:
a flange extending inwardly from the inner surface of the torch ring, designed to extend to a point adjacent the mantle nut and washer assembly to absorb heat generated when the torch ring needs to be cut off of the cone crusher.

10. The torch ring of claim 9 wherein, when mounted to a cone crusher, an open area is defined between the inner surface of the torch ring and the flange for receiving slag and other debris generated during a torch ring cutting operation.

11. The torch ring claim 9 wherein the mantle nut and washer assembly includes a washer, and the flange is designed to extend from the inner surface of the torch ring to a point adjacent the washer when mounted to a cone crusher.
